(19) United States
(12) Patent Application Publication
(10) Pub. No.: US 2013/0098255 A1
(43) Pub. Date: Apr. 25, 2013

(54) COMBINATION PRINTING PRESS

(71) Applicant: KOMORI CORPORATION, Tokyo (JP)

(72) Inventor: Hiroyoshi KAMODA, Tsukuba-shi (JP)

(73) Assignee: KOMORI CORPORATION, Tokyo (JP)

(21) Appl. No.: 13/655,647

(22) Filed: Oct. 19, 2012

(30) Foreign Application Priority Data
Oct. 21, 2011 (JP) 2011-231267

(51) Int. Cl. B41F 7/02

(52) U.S. Cl. 101/217

(57) ABSTRACT

Provided is a combination printing press including a collect-printing unit and an offset printing unit configured to perform offset printing on a paper sheet subjected to collect-printing by the collect-printing unit. The collect-printing unit has a movable inking unit disposed below a paper transport route, and is configured to perform collect-printing on a lower surface of a paper sheet. The offset printing unit includes lower surface offset printing subunits configured to perform offset printing on a lower surface of a paper sheet subjected to the collect-printing by the collect-printing unit. The impression cylinder of a collect-printing subunit and the impression cylinder of the lower surface offset printing subunit are connected by a single transfer cylinder.

### TECHNICAL FIELD

The present invention relates to a combination printing press in which at least a collect-printing press is combined.

### BACKGROUND ART

Complex combinations of printing methods including intaglio printing, relief printing, and lithographic printing are used for printing securities and the like for the proposes of counterfeit prevention and the like. Intaglio printing by which a fine and sharp image can be obtained is used for the portrait and face value. Relief printing which enables printing of legible and sharp letters is used for the serial number. Lithographic (offset) printing suitable for multi-color printing is used for the background pattern. Further, a special printing method, collect-printing, is employed for part of the background pattern.

The collect-printing is a printing method in which inks in several different colors are attached onto pattern plate cylinders, respectively, collected on a single collecting blanket cylinder, and transferred onto a collecting plate cylinder, and then multi-color printing is performed on a sheet by the collecting plate cylinder at once. The collect-printing is also referred to as Sammel printing. The collect-printing has a great counterfeit prevention effect, because the collect-printing has such a characteristic that no registration error occurs at all, when the color is changed in an image.

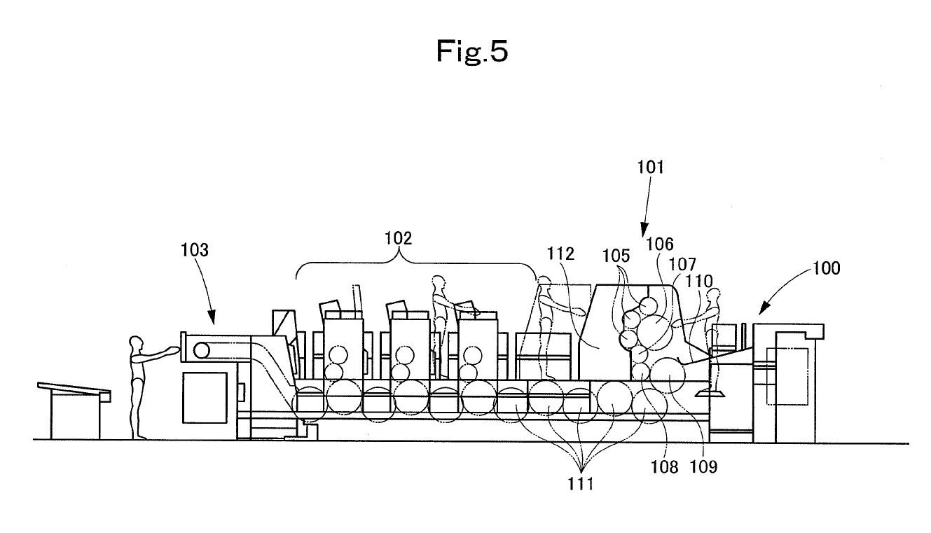

FIG. 5 shows an offset collect-printing press in which a collect-printing unit 101 and an offset printing unit 102 are combined between a sheet feed unit 100 and a sheet delivery unit 103. In the collect-printing unit 101, three pattern plate cylinders (Sammel pattern plate cylinders) 105, a collecting blanket cylinder (Sammel collecting blanket cylinder) 106, a collecting plate cylinder (Sammel collecting plate cylinder) 107, a blanket cylinder 108, and an impression cylinder 109 are connected in this order. Images on the pattern plate cylinders 105 are transferred to and integrated on the collecting plate cylinder 107 through the collecting blanket cylinder 106. Further, the integrated image is printed, through the blanket cylinder 108, on a sheet fed between the blanket cylinder 108 and the impression cylinder 109 by a swing 110. The printed sheet is transferred to a first-color offset printing subunit through five transfer cylinders 111 (see Patent Literature 1).

### CITATION LIST

### Patent Literature

{Patent Literature 1} Japanese Patent Application Publication No. 2003-127321

### SUMMARY OF INVENTION

### Technical Problem

Here, in the collect-printing unit described in Patent Document 1, the cylinder sequence including the three pattern plate cylinders 105, the collecting blanket cylinder 106, the collecting plate cylinder 107, and the blanket cylinder 108 through which the inks are transferred in this order is provided above the transport route of a sheet fed between the blanket cylinder 108 and the impression cylinder 109. In addition, a movable inking unit 112 including a plurality of inking devices configured to supply the inks to the pattern plate cylinders 105, respectively, is provided behind the cylinder sequence (on the downstream side of the sheet transport route, on the offset printing subunit side) and above the sheet transport route.

For this reason, the offset collect-printing press has problems that it is necessary to manage smudges on sheets due to falling of the inks and the like, and that operability of the cylinders is poor, because the operation should be conducted above a footboard or the like. Moreover, the offset collect-printing press also has a problem that the register accuracy is poor, because the collect-printing unit 101 and the offset printing unit 102 need to be connected by many transfer cylinders 111, and consequently the number of times of gripping the sheet is large.

In this respect, an object of the present invention is to provide a combination printing press which enables improvement in operability and printing quality.

### Solution to Problem

In order to achieve the above object, a combination printing press according to the present invention comprises: a collect-printing unit including a collect-printing subunit and a movable inking unit, the collect-printing subunit having a plurality of pattern plate cylinders, a collecting blanket cylinder with which the plurality of pattern plate cylinders are in contact and which has a diameter not less than two times of those of the pattern plate cylinders, a collecting plate cylinder being in contact with the collecting blanket cylinder, a blanket cylinder being in contact with the collecting plate cylinder, and an impression cylinder being in contact with the blanket cylinder, the movable inking unit supporting a plurality of inking devices and being movably supported so as to make the plurality of inking devices capable of moving toward and away from the pattern plate cylinders, the plurality of inking devices being provided respectively for the plurality of pattern plate cylinders and configured to supply ink to the pattern plate cylinders; and

an offset printing unit configured to perform offset printing on a sheet subjected to the collect-printing by the collect-printing unit, wherein

the collect-printing unit has the movable inking unit disposed below a sheet transport route, and is configured to perform collect-printing on a lower surface of the sheet,

the offset printing unit includes a lower surface offset printing subunit configured to perform offset printing on the lower surface of the sheet, the lower surface offset printing subunit having a plate cylinder, a blanket cylinder being in contact with the plate cylinder, an impression cylinder being in contact with the blanket cylinder and having a diameter which is two times of that of the plate cylinder, and an ink supply unit configured to supply ink to the plate cylinder, and

the impression cylinder of the collect-printing subunit and the impression cylinder of the lower surface offset printing subunit are connected by a single transport cylinder.

In addition, the combination printing press is that wherein the movable inking unit is provided on an opposite side of the collecting blanket cylinder from the offset printing unit.

Additionally, the combination printing press is that wherein an intaglio printing unit is provided on a downstream side of the offset printing unit in the sheet transfer direction, and is configured to perform intaglio printing on the sheet.

Moreover, the combination printing press is that wherein the lower surface offset printing subunit is modularized.

Furthermore, the combination printing press is that wherein the offset printing unit includes an upper surface offset printing subunit configured to perform offset printing on an upper surface located on an opposite side from the lower surface of the sheet subjected to the collect-printing by the collect-printing unit, the upper surface offset printing subunit having a plate cylinder, a blanket cylinder being in contact with the plate cylinder, an impression cylinder being in contact with the blanket cylinder and having a diameter which is two times of that of the plate cylinder, and an ink supply unit configured to supply ink to the plate cylinder, and

the impression cylinder of the upper surface offset printing subunit and the impression cylinder of the lower surface offset printing subunit are in contact with each other, and a modularized double-sided printing subunit is constituted by the upper surface offset printing subunit and the lower surface offset printing subunit.

### Advantageous Effects of Invention

The combination printing press according to the present invention enables the collect-printing by the collect-printing unit and the offset printing by the offset printing unit to be performed in an in-line manner.

At this time, it is unnecessary to manage smudges on sheets due to falling of the ink and the like, and the cylinders of the collect-printing unit can be operated on the floor, because the movable inking unit of the collect-printing unit is disposed below the sheet transport route. Moreover, the impression cylinder of the collect-printing subunit and the impression cylinder of the lower surface offset printing subunit are connected by a single transport cylinder. Hence, the number of times of gripping the sheet is reduced.

Consequently, a combination printing press which enables improvement in operability and printing quality can be achieved.

### BRIEF DESCRIPTION OF DRAWINGS

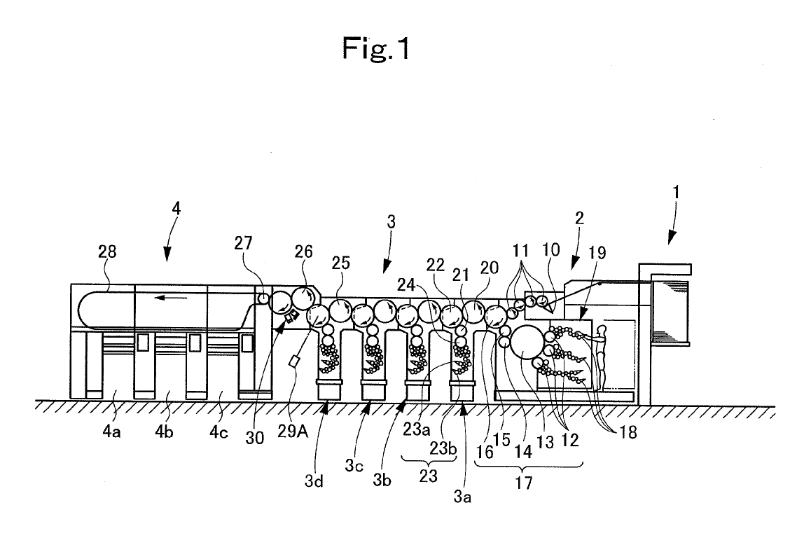

{FIG. 1} FIG. 1 is an overall structural view of a combination printing press showing a first embodiment of the present invention.

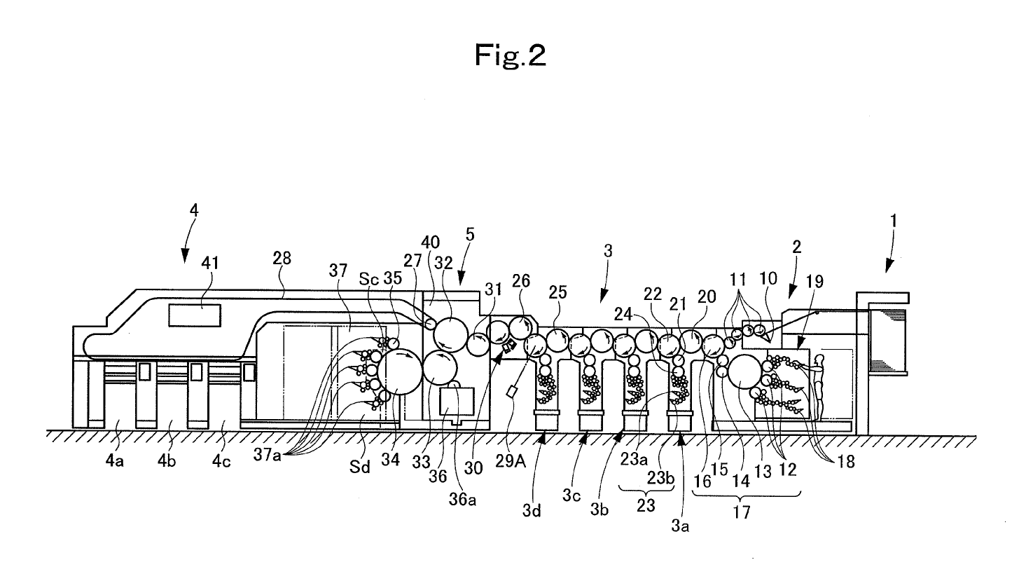

{FIG. 2} FIG. 2 is an overall structural view of a combination printing press showing a second embodiment of the present invention.

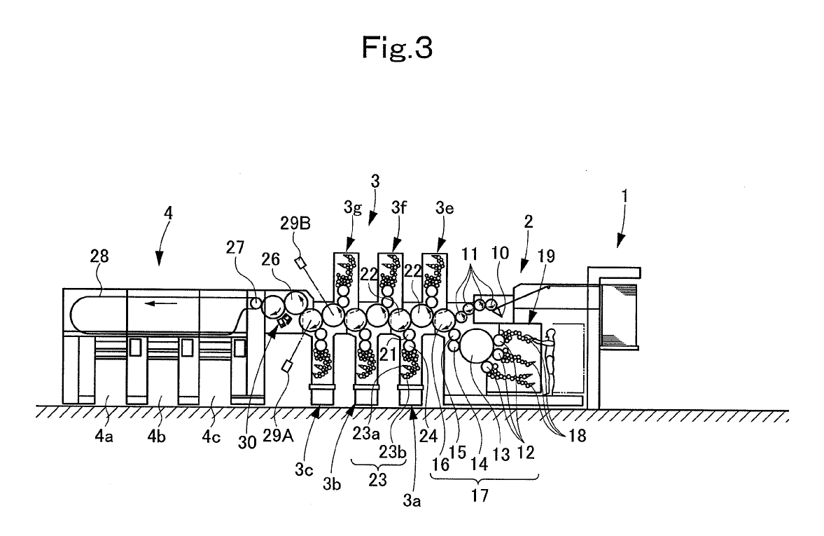

{FIG. 3} FIG. 3 is an overall structural view of a combination printing press showing a third embodiment of the present invention.

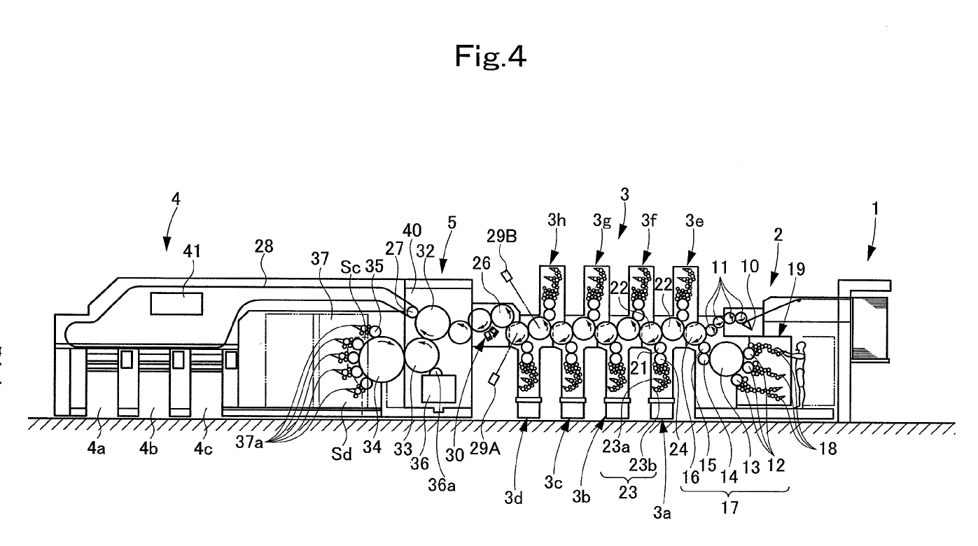

{FIG. 4} FIG. 4 is an overall structural view of a combination printing press showing a fourth embodiment of the present invention.

{FIG. 5} FIG. 5 is an overall structural view of a conventional offset collect-printing press.

### DESCRIPTION OF EMBODIMENTS

Hereinafter, a combination printing press according to the present invention will be described in detail based on embodiments by use of the drawings.

### Example 1

FIG. 1 is an overall structural view of a combination printing press showing a first embodiment of the present invention.

As shown in FIG. 1, a feeder (sheet feed unit) 1 configured to feed paper (sheets), a collect-printing unit 2, an offset printing unit 3, and a delivery unit (sheet delivery unit) 4 configured to deliver paper are disposed in this order from the right. First, a swing 10 passes paper sheets one by one from the feeder 1 through four transfer cylinders 11 to an impression cylinder 16 of the collect-printing unit 2, and the paper sheets are fed between the impression cylinder 16 and a blanket cylinder 15 of the collect-printing unit 2.

The collect-printing unit 2 includes a collect-printing subunit 17 and a movable inking unit 19. The collect-printing subunit 17 has three pattern plate cylinders 12, a collecting blanket cylinder 13 with which the three pattern plate cylinders 12 are in contact, and which has a diameter not less than two times (equal to three times in the example shown in the drawing) of those of the pattern plate cylinders 12, a collecting plate cylinder 14 being in contact with the collecting blanket cylinder 13, the blanket cylinder 15 being in contact with the collecting plate cylinder 14, and the impression cylinder 16 being in contact with the blanket cylinder 15. The movable inking unit 19 supports three inking devices 18, and is movably supported so as to make the three inking devices 18 capable of moving toward and away from the pattern plate cylinders 12. The inking devices 18 are provided for the three pattern plate cylinders 12, respectively, and are configured to supply ink to the pattern plate cylinders 12.

Moreover, in this embodiment, the three pattern plate cylinders 12, the collecting blanket cylinder 13, the collecting plate cylinder 14, and the blanket cylinder 15 of the collect-printing subunit 17, as well as the movable inking unit 19, are disposed below a paper transport route (sheet transport route). Thus, the collect-printing unit 2 is configured to perform collect-printing on a lower surface of a paper sheet. In addition, the movable inking unit 19 is located between the collecting blanket cylinder 13 and the feeder 1, i.e., on the opposite side of the collecting blanket cylinder 13 from the offset printing unit 3, and is movable in the horizontal direction.

Next, the collect-printed paper sheet is fed from the impression cylinder 16 through a single transfer cylinder (transport cylinder) 20 to a portion between a blanket cylinder 21 and an impression cylinder 22 of a first-color lower surface (back surface) offset printing subunit 3a (uppermost stream side offset printing subunit) of the offset printing unit 3.

The offset printing unit 3 includes a double duct-type ink supply unit 23 having two ink fountains 23a and 23b and four lower surface offset printing subunits 3a to 3d each including a plate cylinder 24, the blanket cylinder 21, and the impression cylinder 22. The offset printing unit 3 is configured to print an image in a predetermined color, which is transferred from each of the plate cylinders 24, on the lower surface of the paper sheet fed between the corresponding blanket cylinder 21 and the corresponding impression cylinder 22. In other words, a single transfer cylinder 25 is interposed between the impression cylinders 22 of each adjacent pair of the lower surface offset printing subunits 3a to 3d.

Moreover, in this embodiment, the lower surface offset printing subunits 3a to 3d are modularized separately by colors. This modularization makes it possible to easily handle the increase or decrease in the number of ink colors, and also facilitates the handing during production and assembly. In addition, each of the lower surface offset printing subunits 3a to 3d is configured to perform dry offset printing using no dampening water unit.

Finally, the paper sheets subjected to the offset printing are passed from the impression cylinder 22 of the fourth-color lower surface offset printing subunit 3d through two transfer cylinders 26 to a delivery cylinder 27 of the delivery unit 4. Then, the paper sheets are sequentially transferred by a delivery chain 28, and stacked on piles described later.

Note that a lower surface (back surface) inspection camera 29A is provided to face the impression cylinder 22 of the fourth-color lower surface offset printing subunit 3d, the paper sheets are inspected for the printing quality on the lower surface during transfer by the impression cylinder 22 of the lower surface offset printing subunit 3d. Then, paper sheets determined to be properly processed on the basis of the inspection result by the inspection camera 29A are delivered to, for example, any one of properly processed sheet piles 4a and 4b of the delivery unit 4, whereas paper sheets determined to be improperly processed are delivered to, for example, an improperly processed sheet pile 4c of the delivery unit 4. In addition, reference sign 30 in the drawing denotes a lamp-type UV drying apparatus (UV lamp) which applies UV light (ultraviolet light) to cure and dry instantaneously UV light inks.

With such a configuration, after the collect-printing unit 2 performs the three-color collect-printing, the offset printing unit 3 performs the lower surface four-color offset printing in an in-line manner. This makes it possible to conduct combination printing of two kinds by a single printing press in a one path manner.

In this case, the three pattern plate cylinders 12, the collecting blanket cylinder 13, the collecting plate cylinder 14, and the blanket cylinder 15, as well as the movable inking unit 19, are disposed below the paper transport route, and thus the collect-printing subunit 17 is configured to perform the collect-printing on the lower surface of a paper sheet. Hence, it is unnecessary to manage smudges on paper sheets due to falling of the inks and the like, and the cylinders 12 to 16 of the collect-printing unit 2 can be operated on a floor.

Moreover, the movable inking unit 19 is located between the collecting blanket cylinder 13 and the feeder 1, i.e., on the opposite side of the collecting blanket cylinder 13 from the offset printing unit 3, and is movable in the horizontal direction. Hence, the impression cylinder 16 of the collect-printing subunit 17 and the impression cylinder 22 of the first-color lower surface offset printing subunit 3a can be connected by the single transfer cylinder 20. Hence, the number of times of gripping the paper sheet is reduced, and the register accuracy is improved. Note that when the uppermost stream side offset printing subunit of the offset printing unit is a lower surface offset printing unit as in the case of this embodiment, the transfer cylinder present between the impression cylinder of this lower surface offset printing subunit and the impression cylinder of the collect-printing subunit functions as a transport cylinder of the present invention.

Consequently, a combination printing press can be achieved which enables improvement in operability and printing quality. Moreover, a highly versatile combination printing press can be achieved because of the modularization of the lower surface offset printing subunits 3a to 3d.

### Example 2

FIG. 2 is an overall structural view of a combination printing press showing a second embodiment of the present invention.

In this embodiment, an intaglio printing unit is added to the combination printing press of the first embodiment. Since the other parts of the configuration of this embodiment are the same as those of the configuration of the first embodiment, detailed descriptions thereof are omitted.

As shown in FIG. 2, in the combination printing press of this embodiment, an intaglio printing unit 5 is provided between the offset printing unit 3 and the delivery unit 4. This combination printing press performs intaglio printing on paper sheets subjected to the collect-printing by the collect-printing unit 2 and to the lower surface (one side) offset printing by the offset printing unit 3, and delivers the paper sheets to the delivery unit 4. As a matter of course, the offset printing can be omitted by causing each of the blanket cylinders 21 of the lower surface offset printing subunits 3a to 3d in the offset printing unit 3 to be apart (to disengage) from the impression cylinder 22 and the plate cylinder 24.

The intaglio printing unit 5 includes an impression cylinder 32, an intaglio cylinder 33, an ink-collecting cylinder 34, a wiping device 36, five chablon rollers 35, five ink supply units 37a, and an intaglio printing movable inking unit 37. The impression cylinder 32 is configured to hold and transfer paper sheets passed from the offset printing unit 3 through a transfer cylinder 31. The intaglio cylinder 33 has an intaglio printing plate mounted around a peripheral surface thereof. The ink-collecting cylinder 34 is configured to supply ink to the intaglio cylinder 33. The wiping device 36 includes a wiping roller 36a configured to remove excessive part of the ink transferred onto the intaglio printing plate of the intaglio cylinder 33 by the ink-collecting cylinder 34. The chablon rollers 35 supply ink to the ink-collecting cylinder 34. The five ink supply units 37a are provided respectively for the five chablon rollers 35, and configured to supply ink to the chablon rollers 35. The intaglio printing movable inking unit 37 supports the five ink supply units 37a. Thus, the intaglio printing unit 5 is configured to perform intaglio printing on paper sheets fed between the impression cylinder 32 and the intaglio cylinder 33.

The impression cylinder 32 of the intaglio printing unit 5 is configured to receive paper sheets from the impression cylinder 22 of the lower surface offset printing subunit 3d, which is the last impression cylinder of the offset printing unit 3, through the three transfer cylinders 26, 26, and 31, and, after intaglio printing is performed between the impression cylinder 32 and the intaglio cylinder 33, pass the paper sheets to the delivery cylinder 27. Note that reference sign 41 in the drawing denotes a drying apparatus which dries the ink by blowing hot air or the like onto the lower surfaces of the paper sheets subjected to the offset printing by the offset printing unit 3.

The intaglio printing movable inking unit 37 supporting the five ink supply units 37a is capable of advancing and retreating (throw-on and throw-off) with respect to an intaglio printing unit 40 pivotally supporting the five chablon rollers 35, the ink-collecting cylinder 34, the intaglio cylinder 33, and the impression cylinder 32.

In this embodiment, a work space Sc is formed between each adjacent pair of the chablon rollers 35. This work space Sc provides an access to the ink-collecting cylinder 34 without detaching the chablon rollers 35 in maintenance such as cleaning work of the ink-collecting cylinder 34 and blanket change operation.

In the example shown the drawing, the chablon rollers are arranged in such a manner that the distance between the uppermost chablon roller among the five chablon rollers 35 and the chablon roller immediately below the uppermost chablon roller is larger than the distances of the other pairs of the chablon rollers. Thus, when the intaglio printing movable inking unit 37 is located at a separated position (the position indicated by the chain double-dashed line in the drawing), an operator present in a space Sd formed between the ink supply units 37a and the chablon rollers 35 can access the ink-collecting cylinder 34 through the work spaces Sc.

In other words, the space Sd formed between the ink supply units 37a and the chablon rollers 35 allows access to the ink-collecting cylinder 34 through the work spaces Sc. This allows access to the ink-collecting cylinder 34 by utilizing the work space Sc formed between each adjacent pair of the chablon rollers 35 without performing attachment and detachment of the chablon rollers 35 in maintenance such as cleaning work of the ink-collecting cylinder 34 and blanket change operation. Hence, maintenance operations of the ink-collecting cylinder 34 can be conducted easily.

This embodiment makes it possible to perform printing in any combination of the collect-printing, the lower surface offset printing, and the intaglio printing, and hence wider varieties of demands for printing can be met. This embodiment also makes it possible to perform high-quality printing with high register accuracy, as in the case of the first embodiment.

### Example 3

FIG. 3 is an overall structural view of a combination printing press showing a third embodiment of the present invention.

In this embodiment, the number of the subunits is reduced by one as compared with the offset printing unit 3 in the combination printing press of the first embodiment, and hence the first- to third-color lower surface (back surface) offset printing subunits 3a to 3c are provided. In addition, first- to third-color upper surface (front surface) offset printing subunits 3e to 3g having the same configuration as that of the first- to third-color lower surface offset printing subunits 3a to 3c are provided above the offset printing subunits 3a to 3c. Thus, this embodiment enables double-sided offset printing.

In this embodiment, the impression cylinders 22 of the subunits are connected to one another in a zigzag manner in the paper transfer direction, while the impression cylinders 22 of each adjacent pair of the subunits are in contact with each other. The first-color upper surface offset printing subunit 3e performs offset printing on an upper surface (front surface) of a paper sheet. Then, this paper sheet is passed from the impression cylinder (transport cylinder) 22 of the first-color upper surface offset printing subunit 3e to the impression cylinder 22 of the first-color lower surface offset printing subunit 3a. After that, the first-color offset printing subunit 3a performs offset printing on the lower surface (back surface) of the paper sheet. The impression cylinders 22 of each adjacent pair of the subunits are brought into contact with each other without any transfer cylinder interposed therebetween as described above. With this configuration, upper surface (front surface) printing and lower surface (back surface) printing are alternately performed on a paper sheet. When the uppermost stream side offset printing subunit of the offset printing unit is an upper surface offset printing subunit as in the case of this embodiment, the impression cylinder of this upper surface offset printing subunit functions as the transport cylinder of the present invention.

Note that an upper surface (front surface) inspection camera 29B and the lower surface (back surface) inspection camera 29A are provided to face the impression cylinder 22 of the third-color upper surface offset printing subunit 3g and the impression cylinder 22 of the third-color lower surface offset printing subunit 3c, respectively. Since the other parts of the configuration of this embodiment are the same as those of the configuration of the first embodiment, detailed descriptions thereof are omitted.

This embodiment has the following advantage, in addition to the same operations and effects of the first embodiment. Specifically, after the three-color collect-printing, the three-color offset printing is conducted on the upper surface (front surface) and the lower surface (back surface) in an in-line manner. In addition, offset printing can be conducted only on the lower surface by, for example, causing the blanket cylinders 21 of the upper surface offset printing subunits 3e to 3g to be apart (to disengage) from the impression cylinders 22 and the plate cylinders 24. Thus, it is possible to perform double-sided offset printing and single-sided offset printing on any surface.

### Example 4

FIG. 4 is an overall structural view of a combination printing press showing a fourth embodiment of the present invention.

In this embodiment, the first- to fourth-color lower surface (back surface) offset printing subunits 3a to 3d are provided, and moreover first- to fourth-color upper surface (front surface) offset printing subunits 3e to 3h having the same configuration as that of the first- to fourth-color lower surface offset printing subunits 3a to 3d are provided above these offset printing subunits 3a to 3d in the offset printing unit 3 of the combination printing press of the second embodiment. Thus, this embodiment enables double-sided offset printing.

In this embodiment, the impression cylinders 22 of the subunits are connected to one another in a zigzag manner in the paper transfer direction, while the impression cylinders 22 of each adjacent pair of the subunits are in contact with each other. The first-color upper surface offset printing subunit 3e performs offset printing on an upper surface (front surface) of a paper sheet. Then, this paper sheet is passed from the impression cylinder 22 of the first-color upper surface offset printing subunit 3e to the impression cylinder 22 of the first-color lower surface offset printing subunit 3a. After that, the first-color offset printing subunit 3a performs offset printing on the lower surface (back surface) of the paper sheet. The impression cylinders 22 of each adjacent pair of the subunits are in contact with each other without any transfer cylinder interposed therebetween as described above. With this configuration, upper surface (front surface) printing and lower surface (back surface) printing are alternately performed on a paper sheet.

Note that an upper surface (front surface) inspection camera 29B is provided to face the impression cylinder 22 of the fourth-color upper surface offset printing subunit 3h, as in the case of the fourth-color lower surface offset printing subunit 3d. Since the other parts of the configuration of this embodiment are the same as those in the configuration of the second embodiment, detailed descriptions thereof are omitted

This embodiment has the following advantage, in addition to the same operations and effects of the second embodiment. Specifically, after the three-color collect-printing, the four-color offset printing is conducted on the upper surface (front surface) and the lower surface (back surface) in an in-line manner. In addition, offset printing can be conducted only on the lower surface by, for example, causing the blanket cylinders 21 of the upper surface offset printing subunits 3e to 3h to be apart (to disengage) from the impression cylinders 22 and the plate cylinders 24. Thus, it is possible to perform double-sided printing and single-sided offset printing on any surface.

Note that the present invention is not limited to the above-described embodiments, and it goes without saying that various modifications such as change in the number of the transfer cylinders, the pattern plate cylinders, or the chablon rollers, and change in the number of the subunits in the offset printing unit can be made within a range not departing from the gist of the present invention.

### INDUSTRIAL APPLICABILITY

The combination printing press according to the present invention enables improvement in operability and printing quality, and also has an increased versatility. Hence, the combination printing press can be effectively applied to security printing and the like.

### REFERENCE SIGNS LIST

1 FEEDER

2 COLLECT-PRINTING UNIT

3 OFFSET PRINTING UNIT

3a to 3d LOWER SURFACE (BACK SURFACE) OFFSET PRINTING SUBUNIT

3e to 3h UPPER SURFACE (FRONT SURFACE) OFFSET PRINTING SUBUNIT

4 DELIVERY UNIT

4a, 4b PROPERLY PROCESSED SHEET PILE

4C IMPROPERLY PROCESSED SHEET PILE

5 INTAGLIO PRINTING UNIT

10 SWING

11 TRANSFER CYLINDER

12 PATTERN PLATE CYLINDER

13 COLLECTING BLANKET CYLINDER

14 COLLECTING PLATE CYLINDER

15 BLANKET CYLINDER

16 IMPRESSION CYLINDER

17 COLLECT-PRINTING SUBUNIT

18 INKING DEVICE

19 MOVABLE INKING UNIT

20 TRANSFER CYLINDER

21 BLANKET CYLINDER

22 IMPRESSION CYLINDER

23 INK SUPPLY UNIT

23a, 23b INK FOUNTAIN

24 PLATE CYLINDER

25 TRANSFER CYLINDER

26 TRANSFER CYLINDER

27 DELIVERY CYLINDER

28 DELIVERY CHAIN

29A LOWER SURFACE (BACK SURFACE) INSPECTION CAMERA

29B UPPER SURFACE (FRONT SURFACE) INSPECTION CAMERA

30 UV DRYING APPARATUS (UV LAMP)

31 TRANSFER CYLINDER

32 IMPRESSION CYLINDER

33 INTAGLIO CYLINDER

34 INK-COLLECTING CYLINDER

35 CHABLON ROLLER

37 INTAGLIO PRINTING MOVABLE INKING UNIT

37a INK SUPPLY UNIT

38 TRANSFER CYLINDER

39 INTAGLIO PRINTING SUBUNIT

40 INTAGLIO PRINTING SUBUNIT

41 DRYING APPARATUS

Sc WORK SPACE

Sd SPACE

1. A combination printing press comprising:
a collect-printing unit including a collect-printing subunit and a movable inking unit, the collect-printing subunit having a plurality of pattern plate cylinders, a collecting blanket cylinder with which the plurality of pattern plate cylinders are in contact and which has a diameter not less than two times of those of the pattern plate cylinder, a collecting plate cylinder being in contact with the collecting blanket cylinder, a blanket cylinder being in contact with the collecting plate cylinder, and an impression cylinder being in contact with the blanket cylinder, the movable inking unit supporting a plurality of inking devices and being movably supported so as to make the plurality of inking devices capable of moving toward and away from the pattern plate cylinders, the plurality of inking devices being provided respectively for the plurality of pattern plate cylinders and configured to supply ink to the pattern plate cylinders; and
an offset printing unit configured to perform offset printing on a sheet subjected to the collect-printing by the collect-printing unit, wherein
the collect-printing unit has the movable inking unit disposed below a sheet transport route, and is configured to perform collect-printing on a lower surface of the sheet,
the offset printing unit includes a lower surface offset printing subunit configured to perform offset printing on the lower surface of the sheet, the lower surface offset printing subunit having a plate cylinder, a blanket cylinder being in contact with the plate cylinder, an impression cylinder being in contact with the blanket cylinder and having a diameter which is two times of that of the plate cylinder, and an ink supply unit configured to supply ink to the plate cylinder, and
the impression cylinder of the collect-printing subunit and the impression cylinder of the lower surface offset printing subunit are connected by a single transport cylinder.

2. The combination printing press according to claim 1, wherein the movable inking unit is provided on an opposite side of the collecting blanket cylinder from the offset printing unit.

3. The combination printing press according to claim 2, wherein the lower surface offset printing subunit is modularized.

4. The combination printing press according to claim 2, wherein
the offset printing unit includes an upper surface offset printing subunit configured to perform offset printing on an upper surface located on an opposite side from the lower surface of the sheet subjected to the collect-printing by the collect-printing unit, the upper surface offset printing subunit having a plate cylinder, a blanket cylinder being in contact with the plate cylinder, an impression cylinder being in contact with the blanket cylinder and having a diameter which is two times of that of the plate cylinder, and an ink supply unit configured to supply ink to the plate cylinder, and
the impression cylinder of the upper surface offset printing subunit and the impression cylinder of the lower surface offset printing subunit are in contact with each other, and a modularized double-sided printing subunit is constituted by the upper surface offset printing subunit and the lower surface offset printing subunit.

5. The combination printing press according to claim 2, wherein an intaglio printing unit is provided on a downstream side of the offset printing unit in the sheet transfer direction, and is configured to perform intaglio printing on the sheet.

6. The combination printing press according to claim 5, wherein the lower surface offset printing subunit is modularized.

7. The combination printing press according to claim 5, wherein
the offset printing unit includes an upper surface offset printing subunit configured to perform offset printing on an upper surface located on an opposite side from the lower surface of the sheet subjected to the collect-printing by the collect-printing unit, the upper surface offset printing subunit having a plate cylinder, a blanket cylinder being in contact with the plate cylinder, an impression cylinder being in contact with the blanket cylinder and having a diameter which is two times of that of the plate cylinder, and an ink supply unit configured to supply ink to the plate cylinder, and
the impression cylinder of the upper surface offset printing subunit and the impression cylinder of the lower surface offset printing subunit are in contact with each other, and a modularized double-sided printing subunit is constituted by the upper surface offset printing subunit and the lower surface offset printing subunit.
